(19) United States
(12) Patent Application Publication
(10) Pub. No.: US 2011/0292757 A1
(43) Pub. Date: Dec. 1, 2011

(54) GEARBOX FOR A MIXER-BLENDER

(75) Inventors: Jose Cheio De Oliveira, Saint Hilaire de Loulay (FR); Henri Daheron, Bouffere (FR); Pascal Ricard, Treize Septiers (FR)

(73) Assignee: VMI, Montaigu (FR)

(21) Appl. No.: 13/201,635

(22) PCT Filed: Dec. 11, 2009
(86) PCT No.: PCT/FR09/01417

§ 371 Date: Aug. 16, 2011

(30) Foreign Application Priority Data
Feb. 16, 2009 (FR) 0950974

(51) Int. Cl. F16H 1/28; B01F 7/00

(52) U.S. Cl. 366/272; 475/11

(57) ABSTRACT

The present invention relates to a gearbox for a mixer-blender including a planet wheel (5), a planet carrier (7) comprising a body defining an enclosure, at least one planet gear (6) provided with external teeth and pivotably mounted on the planet carrier (7), said planet gear (6) meshing with the planet wheel (5), and characterised in that the body of the planet carrier (7) is shaped so as to engage with a driving member such that said driving member rotates the planet carrier (7).

### TECHNICAL FIELD

The present invention relates to a gearbox intended to equip a mixer-blender.

### BACKGROUND

Mixer-blenders are used in the food industry, in particular in the bakery and pastry trades to produce dough and creams.

Mixer-blenders conventionally comprise a stand having a carrier column, an upper horizontal part and a lower part, the upper and lower parts being adjacent to the carrier column. A mixer vessel containing the matter to be mixed is then arranged between the lower part and the upper horizontal part of the stand.

Mixer-blenders further comprise a motorized gearbox intended to drive at least one mixer instrument inside the mixer vessel. A gearbox for mixer-blender typically comprises a ring gear, a planet wheel and at least one planet gear. The ring gear is a pinion with inner teeth fixedly mounted on the stand.

The term [symbol] planet wheel [symbol] designates a pinion whose axis of rotation is immobile. The term [symbol] planet gear [symbol] designates a pinion whose own axis of rotation revolves around the axis of rotation of the planet wheel.

In the state of the art, the planet wheel is mounted on a motor shaft whilst the planet gear is pivot mounted on a body called a planet carrier. The planet gear meshes both on the planet wheel and on the ring gear. Finally, the mixer instrument is mounted on the shaft of the planet gear.

The driving of said mixer instrument inside the mixer vessel is produced by the motor shaft. The motor shaft of the plant wheel drives the own rotation of the planet gear. The meshing of the planet gear on the ring gear therefore allows the revolving of the planet gear around the planet wheel. The result is a movement of own rotation and of revolving around the planet wheel of the mixer instrument in the mixer vessel.

In this respect, document FR2844442 describes a gearbox system with epicyclic gear train involving several planet gears to drive several mixer instruments. Said gearbox system has several disadvantages.

The major disadvantage lies in the large amount of space taken up by the gearbox in the upper horizontal part of the stand. This large volume is essentially due to the presence of the motor shaft driving the planet wheel. Additionally, the gearbox motor is integrated in the upper part of the carrier column of the stand. As a result of this arrangement of the motor and of the gearbox system, much axial space is taken up. In the meaning of the present invention by [symbol] axial [symbol] is meant the direction of the carrier column of the stand i.e. the substantially vertical direction.

This axial space requirement leads to the spread of the gearbox into the volume of the mixer vessel, the gearbox thereby creating an annular corridor with the vessel. This annular corridor therefore prevents matter intended to be mixed from being loaded inside the vessel overhead the gearbox. The area for loading ingredients is therefore arranged sideways to the gearbox which may lead to build-up of the ingredients in the area of the annular corridor.

The plant wheel and planet gears are therefore arranged in the area used for loading the matter to be mixed. This arrangement of the planet wheel and planet gears, combined with the extensive axial congestion, then makes it extremely difficult to access the gearbox system for cleaning.

Finally, this axial space requirement is such that it is difficult to envisage the use of a second motor for the gearbox without accentuating the aforementioned shortcomings. Yet a second motor actuating the planet gears either directly or via the planet carrier allows the range of speeds and the range of transmission ratios of the gearbox to be increased. Therefore, this modularity of transmission ratios is difficult to make available with gearbox systems of the state of the art.

### BRIEF SUMMARY

The invention remedies all or part of the aforementioned shortcomings, and for this purpose it comprises a gearbox for a mixer-blender comprising a planet wheel, a planet carrier comprising a body delimiting an enclosure, at least one planet gear provided with external teeth and pivot mounted on the planet carrier, the said planet gear meshing with the planet wheel, and characterized in that the body of the planet carrier is conformed so that it cooperates with a driving member such that the said driving member drives the said planet carrier in rotation.

Therefore the gearbox according to the present invention is designed so that the planet carrier can be driven by a motor; this eliminates the need for the motor shaft present in the state of the art. According to the present invention, the own rotation of the planet gear is initiated directly by the rotation of the planet carrier. As a result, the elimination of the motor shaft of the planet wheel strongly reduces the need for axial space in the upper horizontal part of the stand.

In one embodiment of the present invention, the planet wheel has a fixedly mounted peripheral ring gear provided with inner teeth. The fixed peripheral ring gear wheel allows the revolving of the planet carrier around the centre of the mixer vessel.

According to another embodiment of the invention, the planet wheel, provided with external teeth, is mounted on a motor shaft. As in the preceding embodiment, the planet wheel allows the revolving of the planet carrier around the centre of the mixer vessel. In this configuration with two motors, the adding of a motorized planet wheel allows the transmission ratio of the gearbox to be adjusted. The axial space taken up by the motor shaft of the planet wheel is reduced, compared with a gearbox of the state of the art possibly provided with two motors.

Advantageously, the planet wheel and the planet gear are arranged inside the enclosure of the planet carrier. Therefore, the planet wheel and the planet gear are encapsulated within the body of the planet carrier such that they no longer interfere with the area for loading the matter to be mixed, thereby freeing access to cleaning of the mechanical parts.

According to one characteristic, the planet carrier comprises a pulley body comprising a groove for guiding and housing a drive belt. With this arrangement, it is possible to drive the planet carrier in rotation by means of the drive belt.

The present invention also relates to a device for a mixer-blender comprising a gearbox conforming to the invention and a driving member designed to drive in rotation the planet carrier of the gearbox according to the invention.

According to one characteristic, the driving member comprises a drive belt.

Finally, the present invention also concerns a mixer-blender comprising at least one mixer instrument and first motorization means, equipped with a device conforming to the invention, the said device ensuring the kinematic link between the mixer instrument and the first motorization means so that the first motorization means are connected to the driving member of the device and the mixer instrument is connected to the planet gear.

Preferably, the said mixer-blender further comprises second motorization means connected to the motor shaft of the planet wheel, such that the first and second motorization means respectively actuate the planet carrier by the driving member and the planet wheel by the motor shaft thereof.

According to one characteristic, the mixer-blender further comprises a mixer vessel above which there are arranged means for loading matter to be mixed in a manner adjacent to the body of the planet carrier. Therefore, the loading of the matter to be mixed can be carried out optimally i.e. under gravity since the gearbox does not obstruct the passageway for the matter to be mixed.

### BRIEF DESCRIPTION OF THE DRAWINGS

Other characteristics of the present invention will become apparent on reading the following detailed description of an example of a non-limiting embodiment, with reference to the appended drawings in which:

FIG. 1 is a cross-sectional, front schematic view of a mixer-blender equipped with a gearbox according to the invention, according to one embodiment,

FIG. 2 is a perspective, schematic view of the mixer-blender in FIG. 1;

FIG. 3 is a symbolic diagram of the functioning of a mixer-blender equipped with a gearbox according to the invention, according to a variant of the embodiment shown in FIGS. 1 and 2;

FIG. 4 is a symbolic diagram of the functioning of a mixer-blender equipped with a gearbox according to the invention, according to another embodiment.

### DETAILED DESCRIPTION

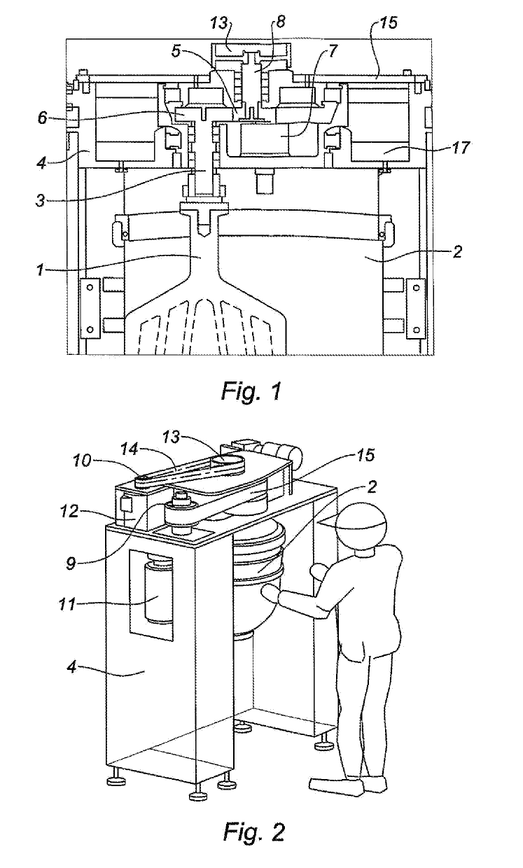

The mixer-blender illustrated in FIG. 1 comprises a mixer instrument 1 inside a mixer vessel 2. The mixer instrument is mounted on a shaft 3. The mixer vessel is arranged underneath the upper horizontal part of a stand 4.

The mixer-blender is also equipped with a gearbox comprising a planet wheel 5 and a planet gear 6. The planet wheel 5 and the planet gear 6 together form a gear system with external teeth. The planet wheel 5 and the planet gear 6 are arranged inside the enclosure of a planet carrier 7, the said planet carrier 7 forming a pulley body. The planet carrier 7 is pivot mounted on the stand 4.

The planet wheel 5 is mounted on a motor shaft 8 whilst the planet gear 6 is mounted on the shaft 3, the said shaft 3 being pivot mounted on the planet carrier 7. The motor shaft 8 is therefore kinematically linked to the shaft 3 on which the mixer instrument is mounted via the gear system with external teeth formed by the planet wheel 5 and the planet gear 6.

The mixer-blender is further provided with means for motorizing the gearbox. A first drive pulley 9 and a second drive pulley 10 are respectively mounted on the shafts of a first motor 11 and of a second motor 12. The first and second motors and the first and second drive pulleys are not illustrated in FIG. 1 but can be seen in FIG. 2.

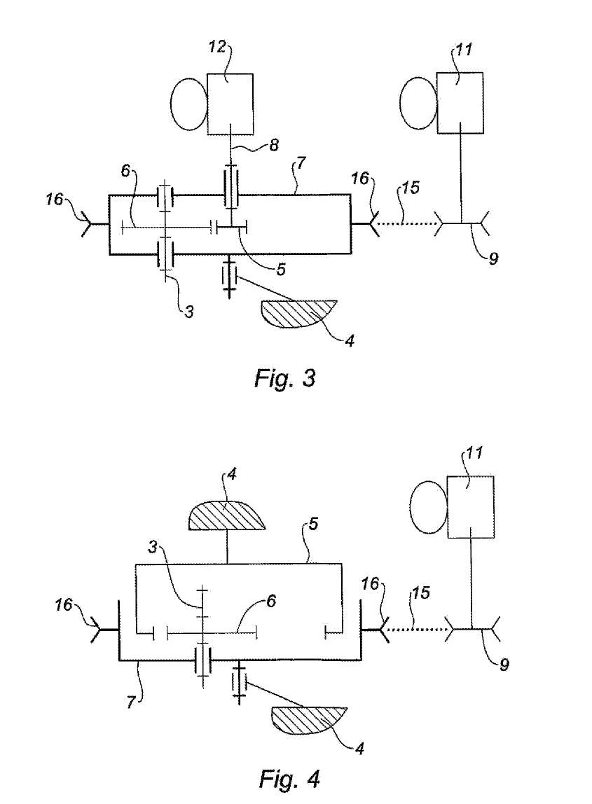

A driven pulley 13 is also directly mounted on the motor shaft 8. The driven pulley 13 and the second drive pulley 10 are connected together by a transmission belt 14. The transmission belt 14 is not visible in FIG. 1 but can be seen in FIG. 2. The first drive pulley 9 and the planet carrier 7 are connected together by a drive belt 15 housed in a guiding and housing groove 16 of the planet carrier 7, the said drive belt 15 allowing the driving in rotation of the body of the planet carrier 7. The guiding and housing groove 16 is not visible in FIG. 1 but is schematically illustrated in FIGS. 3 and 4.

Additionally, an area 17 for the loading of matter to be mixed is arranged above the mixer vessel 2, in manner adjacent to the body of the planet carrier 7.

The functioning of the gearbox according to one embodiment is illustrated by the symbolic diagram in FIG. 3.

The first drive pulley 9 and the second drive pulley 10 respectively drive the planet carrier 7 and the driven pulley 13, and hence the motor shaft 8. This results respectively in actuating the planet gear 6 and the planet wheel 5. The planet gear 6 is therefore actuated both directly by the planet carrier 7 and by meshing with the planet wheel 5. Therefore, the mixer instrument mounted on the shaft 3 is driven both around its own axis and in revolution around the planet wheel 5. The motorization of the planet wheel 5 allows adjustment of the gearbox transmission ratio.

The gearbox is also able to operate with a fixedly mounted planet wheel 5, which is the subject of another embodiment illustrated by the symbolic diagram in FIG. 4.

In this embodiment, the planet wheel 5 has a peripheral ring gear with inner teeth fixedly mounted on the stand 4. In FIG. 4, the planet wheel 5 is located outside the enclosure of the planet carrier 7. However, it is also possible to arrange the planet wheel inside the enclosure of the planet carrier 7, this inner wheel then having external teeth as in the embodiment in FIGS. 1 to 3.

The first drive pulley 9 drives the planet carrier 7 in rotation by means of the drive belt 15. Therefore the planet gear 6 is actuated and comes to mesh on the peripheral ring gear of the planet wheel 5, which means that the mixer instrument mounted on the shaft 3 is driven both around its own axis and in revolution around the peripheral ring gear of the planet wheel 5.

Evidently, the example of embodiment given above does not have any limiting nature, and other details and improvements can be made to the device of the invention without departing from the scope of the invention in which other forms of the device can be obtained.

1. Gearbox for a mixer-blender comprising:
a planet wheel;
a planet carrier comprising a body delimiting an enclosure,
at least one planet gear provided with external teeth, and pivot mounted on the planet carrier, the said planet gear meshing with the planet wheel;
wherein the body of the planet carrier is conformed to cooperate with a driving member so that the said driving member drives the planet carrier in rotation.

2. The gearbox according to claim 1, wherein the planet wheel has a fixedly mounted peripheral ring gear provided with inner teeth.

3. The gearbox according to claim 1, wherein the planet wheel, provided with external teeth, is mounted on a motor shaft.

4. The gearbox according to claim 2, wherein the planet wheel and the planet gear are arranged inside the enclosure of the planet carrier.

5. The gearbox according to claim 1, wherein the planet carrier comprises a pulley body comprising a groove for guiding and housing a drive belt.

6. A device for mixer-blender comprising a gearbox according to claim 1, and a driving member designed to drive in rotation the planet carrier of the gearbox.

7. The device according to claim 6, wherein the driving member comprises a drive belt.

8. A mixer-blender comprising:
at least one mixer instrument;
first motorization means and equipped with a device according to claim 6, the said device ensuring the link between the mixer instrument and the first motorization means so that:
the first motorization means are connected to the driving member of the device;
the mixer instrument is connected to the planet gear.

9. The mixer-blender according to claim 8, wherein the planet wheel, provided with external teeth, is mounted on a motor shaft, the mixer blender further comprising second motorization means connected to the motor shaft of the planet wheel.

10. The mixer-blender according to claim 8, further comprising a mixer vessel above which means are arranged for loading the matter to be mixed, in manner adjacent to the body of the planet carrier.
